(19) United States
(12) Patent Application Publication
(10) Pub. No.: US 2026/0021845 A1
(43) Pub. Date: Jan. 22, 2026

(54) Method for Operating a Motor Vehicle, Control Unit, and Motor Vehicle

(71) Applicant: Robert Bosch GmbH, Stuttgart (DE)

(72) Inventor: Tobias Buchmann, Schwaebisch Gmuend (DE)

(21) Appl. No.: 19/272,893

(22) Filed: Jul. 17, 2025

(30) Foreign Application Priority Data
Jul. 18, 2024 (DE) 10 2024 206 784.9

(51) Int. Cl. B62D 6/00; B60W 10/04; B60W 10/18; B60W 10/20; B60W 30/12; B62D 1/04; B62D 15/02

(52) U.S. Cl. CPC B62D 6/006; B60W 10/04; B60W 10/18; B60W 10/20; B60W 30/12; B62D 15/024; B62D 15/0245; B60W 2510/20; B60W 2552/40; B60W 2552/53; B60W 2710/18; B60W 2710/207; B62D 1/04

(57) ABSTRACT

In a method for operating a motor vehicle, which has a steering system with a driver-actuatable steering handle for specifying a steering request, and at least one wheel with a steering angle that is adjustable by the steering system, when an actual and/or expected deviation of an actual trajectory of the motor vehicle from a target trajectory of the motor vehicle is detected, a steering profile for the steering handle is asymmetrically modified for triggering an actuator associated with the steering system. In addition, in the method, a change in a steering angle of the wheel towards the target trajectory when the steering handle is actuated by the driver is more strongly supported than a change counter to the direction of the target trajectory.

This application claims priority under 35 U.S.C. § 119 to application no. DE 10 2024 206 784.9, filed on Jul. 18, 2024 in Germany, the disclosure of which is incorporated herein by reference in its entirety.

The disclosure relates to a method for operating a motor vehicle, wherein the motor vehicle comprises a steering system having a driver-actuatable steering handle, in particular a driver-rotatable steering wheel, for specifying a steering request, and wherein the motor vehicle comprises at least one wheel, whose steering angle is adjustable by the steering system. In addition, the disclosure relates to a control unit that is specifically configured for performing such a method, as well as to a motor vehicle having such a control unit.

### BACKGROUND

It is known to use a steering profile for the steering handle for triggering an actuator associated with the steering system. Such steering profiles are typically designed symmetrically, for example in a rack-and-pinion steering to the center of the teeth. This means that, independently of the actuation device, in particular the direction of rotation for a steering wheel, a steering request is consistently implemented.

From the patent specification EP 1 888 394 B1 of the Applicant, a lane-keeping assist for motor vehicles is known, having a sensor device for detecting lanes on the roadway, a control unit that exerts a force to the steering of the vehicle via an actuator in order to keep the vehicle in the lane, and a device for detecting a lane change intent of the driver, wherein the control unit is configured so as to modify the force exerted on the steering asymmetrically in the sense of an easier lane change when the lane change intent is detected.

### SUMMARY

In the method according to the disclosure, when an actual and/or expected deviation of an actual trajectory of the motor vehicle from a target trajectory of the motor vehicle is detected, a steering profile for the steering handle is asymmetrically modified for triggering an actuator associated with the steering system, in that a change in a steering angle of the wheel towards the target trajectory when the steering handle is actuated by the driver is more strongly supported than a change counter to the direction of the target trajectory. Thus, if the driver attempts to counter-steer in order to achieve the adjusted target trajectory again, the driver is advantageously supported by the modification of the steering profile according to the disclosure, which is asymmetric in that it is more pronounced in the direction of the adjusted trajectory, in particular only in the direction of the adjusted trajectory. In the event of such a deviation of the actual trajectory from the target trajectory caused by, for example, certain external conditions that are only present on one side in relation to a direction of travel of the vehicle, it is advantageous to deviate from the symmetry of the steering profile mentioned and to prefer a certain steering direction, namely the one that leads back to the original target trajectory. In the corresponding travel situations, an asymmetric steering profile is provided in this respect, for example in the presence of u-split conditions, driving over roadway markings, and/or exiting the roadway. The driver is then supported by the method according to the disclosure in a targeted manner in order to steer in a desired direction, for example if the wheels have already come off the roadway. Preferably, it is contemplated that only a change in a steering angle of the wheel towards the target trajectory is supported when the driver operates the steering handle. The modification is at least temporarily active, i.e., at least as long as the actual trajectory deviates from the target trajectory. In particular, it is a steering system according to the steer-by-wire principle, such that not only steering support but also a steering ratio can be adapted accordingly. A further departure from the trajectory is thus advantageously made more difficult, for example because the steering support is lower in comparison and/or the steering ratio is more indirect. Thus, it is provided in the aforementioned lane-keeping assist that an actuator asymmetrically modifies a force exerted on a steering in the context of an intended lane change. The actuator itself is meant to act on the trajectory of the motor vehicle by performing a direct automatic steering intervention. The asymmetry of the actuator serves to ensure that the driver does not have to overcome any opposing force of the actuator when steering in the “correct” direction. In this respect, a result similar to the mentioned lane-keeping assist is achieved by the method according to the disclosure, with the difference that no active/direct automatic steering intervention for lane-keeping occurs, but rather only a corrective steering intervention by the driver is more strongly supported, in particular more directly translated. Conversely, the method according to the disclosure is generally suitable for functionally supporting or even replacing such a lane-keeping assist. Purely as a precautionary measure, it is noted that the disclosure is not limited to a particular type of steering handle, but in particular a steering wheel or joystick are contemplated.

According to a further development of the disclosure, it is provided that, with the steering profile, at least one input variable characterizing an actuation of the steering handle is assigned to at least one output variable used for the actuation of the actuator. The corresponding allocation advantageously ensures that the behavior resulting from the steering profile is repeatably consistent. For example, an actuation path, in particular a turning angle of a steering wheel or a displacement path of a joystick, is taken into account and associated with an output variable, which in particular characterizes a steering effect. Preferably, a plurality of input variables are considered, and corresponding outputs are associated. For example, at least one trigger variable for the actuator is used as the output variable, in particular an electrical trigger current and/or a steering angle to be achieved. Preferably, the steering profile is provided as a characteristic curve or characteristic map in order to match the corresponding variables to one another in a consistent manner.

Particularly, it is contemplated that a steering support and/or a steering ratio of the steering profile is/are modified. The steering support and/or steering ratio ensure a particularly advantageously simple modification of the steering profile. For example, a corresponding steering operation towards the target trajectory is supported by greater steering support and/or a more direct steering ratio. The steering support can in particular be directly applied at the steering handle, thus facilitating its actuation by triggering of the actuator, and/or can comprise an amplified triggering of the actuator associated with the steering system in the sense of power steering, wherein the actuator then directly changes the steering angle of the wheel as a function of the actuation of the steering handle. The actuator is configured in particular as a rack actuator of a rack-and-pinion steering or as a single-wheel actuator. Preferably, a plurality of triggerable actuators are provided.

According to a further development of the disclosure, it is provided that the steering support is amplified towards the target trajectory and/or the steering ratio becomes more direct. By a corresponding adaptation of steering support and/or steering ratio, it is advantageously ensured that the actuation of the steering handle in the direction of the target trajectory is directly promoted, for example by supporting active steering back onto the roadway. A “more direct steering ratio” in the present case is understood to mean that a gear ratio is reduced, for example, with a consistent turning angle of the steering handle configured as a steering wheel, a greater steering angle is adjusted on the wheel than before the modification. Thus, the target trajectory is regained faster when the steering handle is actuated in the direction thereof.

Particularly, it is provided that the steering support decreases counter to the direction of the target trajectory and/or the steering ratio of the steering profile becomes more indirect. By a corresponding adjustment of steering support and/or steering ratio, it is advantageously ensured that the actuation of steering handle is indirectly promoted counter to the direction of the target trajectory by counteracting a further departure, for example, from the road. A “more indirect steering ratio” in the present case is understood to mean that a gear ratio is increase, for example, with a consistent turning angle of the steering handle configured as a steering wheel, a smaller steering angle is adjusted on the wheel than before the modification. Thus, a further departure from the target trajectory is made more difficult when the steering handle is actuated counter to the direction of the target trajectory.

According to a further development of the disclosure, it is provided that the steering profile, in particular a steering support and/or a steering ratio of the steering profile, is modified as a function of an actuation path of the steering handle, in particular a rotational position of the steering wheel, a steering direction, a current steering angle, an amount of deviation, and/or a driving situation. By way of a correspondingly dependent modification, it is advantageously ensured that the steering profile is adapted precisely to the situation. For example, the asymmetry can begin halfway in the center of the actuation path of the steering handle or can also begin off-center. A subdivision into more than two regions is also contemplated. It is also contemplated to make the modification dependent solely on the steering direction, in particular a direction of movement of the steering movement, such that a steering in a particular direction is more strongly supported, independent of a current steering angle. The strength of the modification, in particular a changed steering support and/or steering ratio, is thus dependent on, for example, an actuation path, steering direction, steering angle, deviation, and/or driving situation.

Particularly, it is provided that the steering profile, in particular a steering support and/or steering ratio of the steering profile, is modified by a specified constant or characteristic. This results in the advantage that the steering profile is particularly simply and consistently modified.

According to a further development of the disclosure, it is provided that a center return of the steering handle is modified into a position, in particular a rotational position, associated with a straight-line travel of the motor vehicle in that a center used as a reference in the steering profile is shifted. This creates a particularly robust possibility for modifying the steering profile.

Particularly, it is provided that a drive system and/or brake system, which is/are associated in particular with the same wheel of the motor vehicle as the steering system, is additionally triggered in the steering profile. Such an additional actuation of the brake system and/or drive system results in the advantage that the support in steering back is further increased. The drive system and/or brake system can also be associated, in particular in the context of a torque vectoring, with a different wheel than the steering system. In particular, a corresponding actuator of the brake system and/or the drive system is triggered so that an advantageous multi-actuator triggering is present overall, i.e., not only an actuator associated with the steering system is triggered, but rather additional acceleration interventions and/or braking interventions occur which stabilize the vehicle or return the vehicle to the target trajectory as the originally specified course. For example, a corresponding electric prime mover and/or wheel-braking device are triggered on the respective wheel.

According to a further development of the disclosure, it is provided that, for detecting the deviation of the actual trajectory from the target trajectory, the motor vehicle and/or a surrounding environment of the motor vehicle is/are monitored for the presence of u-split conditions and/or for exiting a lane, roadway, and/or a route specified by a navigation system. Such monitoring advantageously ensures that a corresponding deviation is always detected safely and in a timely manner. In particular, the asymmetry is used in order to support certain travel directions or directional decisions, for example in combination with the aforementioned navigation system. Preferably, the steering profile is then asymmetrically modified such that a direction corresponding to the route specified by the navigation system is easier to control than a “wrong” turn. In particular, the modification is only carried out when there is actually a deviation of the trajectories, alternatively already when a deviation is expected at least with a certain probability, for example as a function of a surrounding environment and/or environmental condition, in particular a road surface, roadway friction value, and/or weather. Preferably, the monitoring is carried out by means of a corresponding sensor assembly comprising, for example, an optical sensor, in particular a camera sensor, and/or an inertial sensor/acceleration sensor.

Particularly, it is provided that the modification of the steering profile will end when the actual trajectory again corresponds to the target trajectory. This results in the advantage that the method is only applied as needed, wherein the modified steering profile is only maintained for as long as the deviation is detected and subsequently returned to an in particular symmetrical output steering profile. In order to detect whether the trajectories correspond to each other again, the motor vehicle is monitored, in particular as described in the previous paragraph.

The control unit according to the disclosure is specifically configured so as to perform the method according to the disclosure. The advantages specified hereinabove are achieved as a result. In particular, the control unit is designed as a computer device which is assigned to a motor vehicle and is preferably arranged in a motor vehicle. The control unit is associated with the steering system, for example.

The motor vehicle according to the disclosure comprises a steering system with at least one driver-actuatable steering handle, in particular a driver-rotatable steering wheel, for providing a steering request, and at least one wheel whose steering angle is adjustable by the steering system, and is characterized by the control unit according to the disclosure. This also results in the advantages specified hereinabove.

### BRIEF DESCRIPTION OF THE DRAWINGS

Further features and combinations of features result from the previous description and from the claims. The disclosure is explained in more detail below with reference to the drawings. Shown are:

FIG. 1 a motor vehicle, and

FIG. 2 a method for operating the motor vehicle.

### DETAILED DESCRIPTION

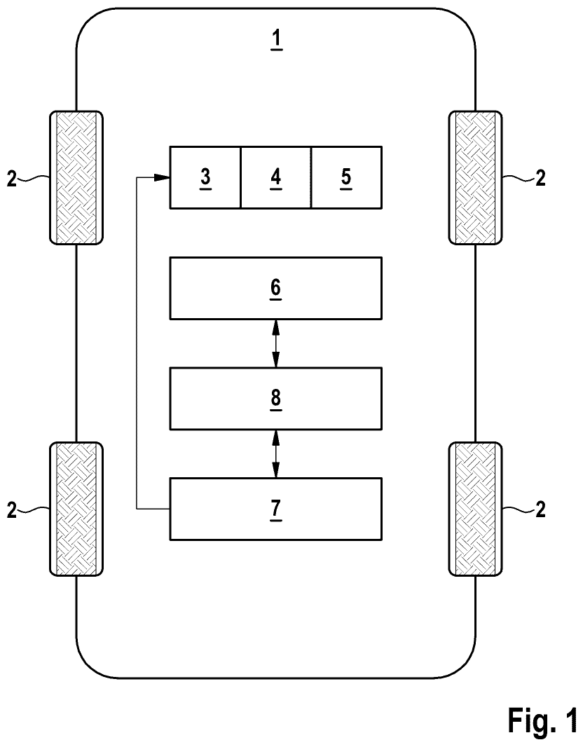

FIG. 1 shows a motor vehicle 1. The motor vehicle 1 comprises four wheels 2, wherein at least one of the wheels 2, in particular at least two wheels 2 of the same axle, is respectively associated with a drive system 3, a brake system 4, and a steering system 5 of the motor vehicle 1 in order to accelerate, decelerate, and/or steer the motor vehicle 1. For this purpose, each of the systems 3, 4, 5 comprises at least one controllable actuator.

The motor vehicle 1 further comprises a steering handle 6, which is configured in particular as a steering wheel. The steering handle 6 is configured so as to be actuated by a driver in order to specify a steering request.

The steering request is then implemented by the steering system 5 as a function of a specified steering profile, in particular by triggering the corresponding actuator (not shown here), such that the steering angle of at least one of the wheels 2 is adjusted by the steering system 5.

Finally, the motor vehicle also comprises a control unit 7, which is configured so as to convert an actuation of the steering handle 6, which is in the present case has been detected by a corresponding sensor assembly 8 associated with the steering handle 6 and comprising in particular a travel sensor and/or a turning angle sensor, into a corresponding trigger signal for the steering system 5.

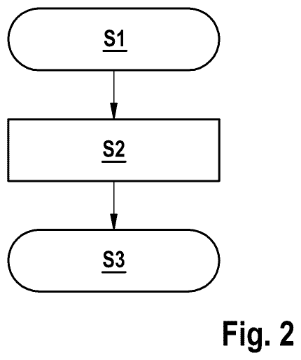

The following describes an advantageous method for operating the motor vehicle 1, with reference to FIG. 2. For this purpose, FIG. 2 shows the method in the form of a flow chart. In particular, the method ensures that a change in a steering angle of at least one of the wheels towards a target trajectory is supported by the driver when the steering handle 6 is actuated. The method is carried out in particular by means of the control unit 7.

In a step S1, the method begins by comparing an actual trajectory of the motor vehicle to a target trajectory of the motor vehicle 1. If an actual and/or expected deviation is detected, the method is continued with a step S2.

In order to detect the deviation of the actual trajectory from the target trajectory, the motor vehicle 1 and/or a surrounding environment of the motor vehicle 1 is/are monitored in particular for the presence of μ-split conditions and/or for exiting a lane, roadway, and/or a route specified by a navigation system.

In step S2, the steering profile for the steering handle 6 is modified asymmetrically for triggering the actuator associated with steering system 5, such that a change in a steering angle of at least one wheel 2 associated with the steering system, in particular the two corresponding wheels 2 of the front axle of the motor vehicle 1, towards the target trajectory when the steering handle 6 is actuated by the driver is more strongly supported than a change in the direction of the target trajectory.

With the steering profile, at least one input variable characterizing an actuation of the steering handle 6, for example a turning angle of the steering wheel, is assigned to at least one output variable used for the actuation of the actuator.

Preferably, a steering support and/or a steering ratio of the steering profile is/are modified, wherein, for example, the steering support is amplified towards the target trajectory, the steering support is decreased counter to the direction of the target trajectory, the steering ratio becomes more direct towards the target trajectory, and/or the steering ratio becomes more indirect counter to the direction of the target trajectory.

The steering profile, in particular a steering support and/or a steering ratio of the steering profile, is preferably modified as a function of an actuation path of the steering handle 6, in particular a rotational position of the steering wheel, a steering direction, a current steering angle, an amount of deviation, and/or a driving situation, for example by a specified constant or characteristic.

Alternatively or additionally, a center return of the steering handle 6 is modified into a position, in particular a rotational position, associated with a straight-line travel of the motor vehicle 1 in that a center used as a reference in the steering profile is shifted.

Particularly preferably, a drive system 3 and/or brake system 4, which is in particular associated with the same wheel 2 of the motor vehicle 1 as the steering system 5, is additionally triggered in the steering profile.

If, for example, it is detected by continued monitoring as described above that the actual trajectory again corresponds to the target trajectory, the modification of the steering profile is ended. The method then ends with the step S3.

1. A method for operating a motor vehicle, which has (i) a steering system having a driver-actuatable steering handle for specifying a steering request and (ii) at least one wheel defining a steering angle that is adjustable by the steering system, the method comprising:
when an actual and/or expected deviation of an actual trajectory of the motor vehicle from a target trajectory of the motor vehicle is detected, asymmetrically modifying a steering profile for the steering handle for triggering an actuator associated with the steering system,
wherein a change in a steering angle of the wheel towards the target trajectory when the steering handle is actuated by a driver is more strongly supported than a change counter to a direction of the target trajectory.

2. The method according to claim 1, wherein at least one input variable characterizing an actuation of the steering handle is assigned to at least one output variable used for the actuation of the actuator in the steering profile.

3. The method according to claim 1, wherein the asymmetric modifying of the steering profile includes modifying at least one of a steering support and a steering ratio of the steering profile.

4. The method according to claim 3, wherein the modifying of the at least one of the steering support and the steering ratio of the steering profile includes amplifying the steering support towards the target trajectory and/or modifying the steering ratio to become more direct.

5. The method according to claim 3, wherein the modifying of the at least one of the steering support and the steering ratio of the steering profile includes decreasing the steering support counter to the direction of the target trajectory and/or modifying the steering ratio to become more indirect.

6. The method according to claim 1, wherein the asymmetric modifying of the steering profile includes modifying the steering profile as a function of at least one of an actuation path of the steering handle, a steering direction, a current steering angle, an amount of deviation, and a driving situation.

7. The method according to claim 1, wherein the asymmetric modifying of the steering profile includes modifying the steering profile by a specified constant or characteristic.

8. The method according to claim 1, wherein the asymmetric modifying of the steering profile includes modifying a center return of the steering handle into a position associated with a straight-line travel of the motor vehicle by shifting a center used as a reference in the steering profile.

9. The method according to claim 1, wherein a drive system and/or brake system associated with the at least one wheel of the motor vehicle is additionally triggered in the steering profile.

10. The method according to claim 1, further comprising detecting the deviation of the actual trajectory from the target trajectory by monitoring the motor vehicle and/or a surrounding environment of the motor vehicle for at least one of (i) μ-split conditions, and (ii) exiting a lane, roadway, and/or a route specified by a navigation system.

11. The method according to claim 1, further comprising ending the asymmetric modifying of the steering profile when the actual trajectory again corresponds to the target trajectory.

12. The method according to claim 1, wherein the driver-actuatable steering handle is a driver-rotatable steering wheel.

13. A control unit comprising:
a computer device specifically configured to perform the method according to claim 1.

14. A motor vehicle comprising:
a steering system with at least one driver-actuatable steering handle configured to provide a steering request;
at least one wheel having a steering angle that is adjustable by the steering system; and
a control unit configured to, when an actual and/or expected deviation of an actual trajectory of the motor vehicle from a target trajectory of the motor vehicle is detected, asymmetrically modify a steering profile for the steering handle for triggering an actuator associated with the steering system,
wherein a change in a steering angle of the wheel towards the target trajectory when the steering handle is actuated by a driver is more strongly supported than a change counter to a direction of the target trajectory.

15. The motor vehicle according to claim 14, wherein the driver-actuatable steering handle is a driver-rotatable steering wheel.
